(19) United States
(12) Patent Application Publication
(10) Pub. No.: US 2014/0082001 A1
(43) Pub. Date: Mar. 20, 2014

(54) DIGITAL FORENSIC AUDIT SYSTEM FOR ANALYZING USER'S BEHAVIORS

(71) Applicant: Duzon Information Security Service, Chuncheon-si (KR)

(72) Inventors: Tae Hoon Jang, Chuncheon-si, Gangwon-do (KR); Hong Sun Lee, Chuncheon-si, Gangwon-do (KR); Hyo Geun Gwak, Chuncheon-si, Gangwon-do (KR); Hong Gyu Jeon, Guri-si, Gyeonggi-do (KR); Jong Hyun Kim, Gangnam-gu, Seoul (KR); Bong Seok You, Gangnam-gu, Seoul (KR); In Hyun Bark, Gangnam-gu, Seoul (KR); Jin Hak Kim, Yongin-si, Gyeonggi-do (KR); Jong Seong Ham, Gwangjin-gu, Seoul (KR)

(21) Appl. No.: 13/905,816

(22) Filed: May 30, 2013

(30) Foreign Application Priority Data
Sep. 14, 2012 (KR) 10-2012-0102263

(51) Int. Cl. G06F 17/30

(52) U.S. Cl. CPC G06F 17/30572
USPC 707/755

(57) ABSTRACT

A digital forensic audit system which extracts the event and the document file from the image, analyzes the event and the document file to visualize the event and document file in order to analyze a user's behaviors by scanning a usage trace and a file which is an image recorded in a window system, the system includes a document file extracting unit which extracts a logical level document file and an attribute of the document file from the image; an event extracting unit which extracts an event including time of occurrence from the image and extracts an event from an attribute of the document file related to the time (hereinafter, referred to as a time attribute), an analyzing unit which analyzes the document file or the event by the attribute and the time; and a visualizing unit which displays the analyzed result (hereinafter, referred to as an analysis result) on a time coordinate.

### CROSS-REFERENCE TO RELATED APPLICATIONS

This application is based on and claims priority from Korean Patent Application No. 10-2012-0102263, filed on Sep. 14, 2012, with the Korean Intellectual Property Office, the disclosure of which is incorporated herein in its entirety by reference.

### TECHNICAL FIELD

The present disclosure relates to a digital forensic audit system for analyzing a user's behaviors which scans a usage trace and a file which are recorded in a window system to analyze a user's behavior.

Specifically, the present disclosure relates to a digital forensic audit system for analyzing the user's behaviors which scans an image recorded in a storage medium to extract an event and a document file from the image and analyzes the event and the document file to visualize the event and the document file according to the time.

### BACKGROUND

In recent years, due to the rapid propagation of computers, many parts of private life are connected with the computer. In accordance with this trend, some important evidences are found from a criminal, a computer system or various storage devices related thereto during crime investigation so that attention of the related institution is concentrated thereon. This indicates that a digital evidence is very useful when not only a computer related crime such as computer hacking, but also a general crime is investigated and is likely to be chosen as a legal evidence.

The digital forensic is formally defined as scientific and logical procedure and method which collect, store, analyze, and report data and is also defined as a technique which investigates and proves a fact relevant to some behaviors which are performed using a computer as a medium mainly based on a digital material embedded in the computer in view of a purpose. For this reason, an evidence needs to be obtained without damaging an original digital material so that it can be proved that the computer evidence is present at that time and the evidence is analyzed, and then the evidence needs to be written as a document in order to be chosen as an evidence in a court of law. Therefore, a major investigative agency from major countries and financing or insurance companies which treat a sensitive material recognize an importance of a digital forensic field and secure an expert or various related technologies and spur the developments of a collecting procedure, an analyzing method, and a searching technology of the digital evidence. Among them, the digital evidence searching technology is one of the core technologies utilized for the digital forensic and plays an important role to allow a detective to find decisive or associated information related to the criminal from a mass storage medium within a limited time.

Digital forensic search tools which have been known until now perform simple matching in a bit stream unit at a physical level in order to search a given search keyword or builds an index. These methods are designed to search all matching patterns stored in the medium with respect to a given query language and as a result, a significant amount of data including irrelevant documents is calculated. One of important requirements of the search tool is to suggest all results which are requested in the digital forensic without omission.

However, the search tools of the related art do not perform appropriate filtering or grouping process on the results but simply suggest the results such that the detective needs to spend a lot of time to find documents related to the investigation among the searched documents.

Specifically, a desktop search technology or a file system search technology for the mass storage medium (a hard disk or a database) which is provided in a PC or a server as a local device builds an index for the document and searches a query based on the index. However, in order to search all data which is required in forensics, it takes enormous time to build an initial index and a disk having a huge size is required to store the index.

In the related art, a method that displays registry information in parallel on a screen for every item of the registry while analyzing the registry is mainly used but according to this method, it is difficult to understand a flow of the file migration or duplication with respect to the usage of the medium and the scope is limited to the registry analysis. Therefore, due to the level of difficulty and the high cost of the analysis, the forensic analysis technology of the related art is not operated (applied) for a general medium or small size company (or organization) at all times.

However, an importance of preventing information leakage by a malicious or intentional insider for a file including industrial secrete information which is worth as a main asset in the company such as a business plan, a drawing, a development specification, or a report, or private information is increased. In a method that uses a portable storage medium as an example of general information leakage types by the insider, the storage medium includes an external hard disk, a CD-RW, or a USB storage device. For example, information is output to the outside through an outputting device such as a printer or leaked to the outside by online file attachment through an electronic mail, a web-mail, FTP, P2P, or a messenger program.

Accordingly, if the forensic audit of a storage medium in an organization is easily performed, it is possible to prevent the digital asset from being leaked to the outside.

### SUMMARY

The present disclosure has been presented to solve the aforementioned problem, and has been made in an effort to provide a digital forensic audit system for analyzing a user's behaviors which scans an image recorded in a storage medium to extract an event and a document file from the image and analyzes the event and the document file to visualize the event and the document file.

The present disclosure also provides a digital forensic audit system for analyzing a user's behaviors which extracts a logical level document file and an event from the recorded image, extracts a time attribute and displays the analysis result on a time coordinate to visualize the analysis result.

To this end, according to the present disclosure, a digital forensic audit system for analyzing a user's behaviors which scans an image recorded in a storage medium to extract an event and a document file from the image and analyzes the event and the document file to visualize the event and the document file, includes a status extracting unit which extracts a system status from the recorded image; a document file extracting unit which extracts the document file and an attribute of the document file from the recorded image; an event extracting unit which extracts an event including time of occurrence from the recorded image and extracts an event from an attribute of the document file related to the time (hereinafter, referred to as a time attribute); an analyzing unit which analyzes the document file or the event by the attribute and the time; and a visualizing unit which displays the analyzed result (hereinafter, referred to as an analysis result) on a time coordinate.

In the digital forensic audit system for analyzing a user's behaviors, the visualizing unit sets a horizontal axis of the coordinate as an axis of the time and a vertical axis as an event or a document file to display the analysis result.

In the digital forensic audit system for analyzing a user's behaviors, the visualizing unit displays a rod (hereinafter, referred to as a time line) which displays a section of the horizontal axis and adjusts the section of the horizontal axis by adjusting the width of the rod between the left and right.

In the digital forensic audit system for analyzing a user's behaviors, the time attribute of the document file includes a file generation date and a file correction date.

In the digital forensic audit system for analyzing a user's behaviors, if the document file (hereinafter, an upper level file) includes a document file (hereinafter, a lower level file), the document file extracting unit extracts the lower level file as one document file.

In the digital forensic audit system for analyzing a user's behaviors, the event extracting unit extracts an event of the upper level file as an event of the lower level file.

In the digital forensic audit system for analyzing a user's behaviors, if the upper level file is a mail, the lower level file is a file which is attached to the mail and if the upper level file is a zip file, the lower level file is a compressed file.

In the digital forensic audit system for analyzing a user's behaviors, if occurrence times of at least two events are equal, the analyzing unit sets a correlation of the events and sets a correlation between the event and the document file to the document file which is extracted as the event.

In the digital forensic audit system for analyzing a user's behaviors, if a file name of the event is equal to a file name of the document file, the analyzing unit sets the correlation between the event and the document file.

As described above, according to the digital forensic audit system for analyzing a user's behaviors, an image stored in a storage medium such as a hard disk is automatically analyzed so as to be visualized and displayed so that the forensic audit on a storage medium of a computer terminal of a normal organization is easily performed to analyze a user's behaviors.

Specifically, according to the digital forensic audit system for analyzing a user's behaviors, the forensic analysis result is intuitively visualized so that an untrained worker may easily perform the forensic analysis even in a small sized organization.

Ultimately, according to the digital forensic audit system for analyzing a user's behaviors, it is possible to easily monitor the intentional and illegal external leakage of secret information or private information in the organization at all times and promptly obtain an evidence when an accident occurs.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view illustrating an example of an entire system configuration in order to carry out the present disclosure.

FIG. 2 is a block diagram illustrating a configuration of a digital forensic audit system for analyzing a user's behaviors according to an exemplary embodiment of the present disclosure.

FIGS. 3 to 8 illustrate examples of a screen of the digital forensic audit system for analyzing a user's behaviors according to the exemplary embodiment of the present disclosure.

### DETAILED DESCRIPTION

In the following detailed description, reference is made to the accompanying drawing, which form a part hereof. Hereinafter, a configuration of the present disclosure and an operation and advantages in accordance with the configuration will be apparent from the following detailed description. Like reference numerals designate like elements throughout the specification. A detailed explanation of known related functions and constitutions may be omitted when it is determined that the detailed explanation obscures the subject matter of the present disclosure.

Hereinafter, details for carrying out the present disclosure will be described with reference to the drawings.

In the description, the same part is denoted by the same reference numeral and a redundant description will be omitted.

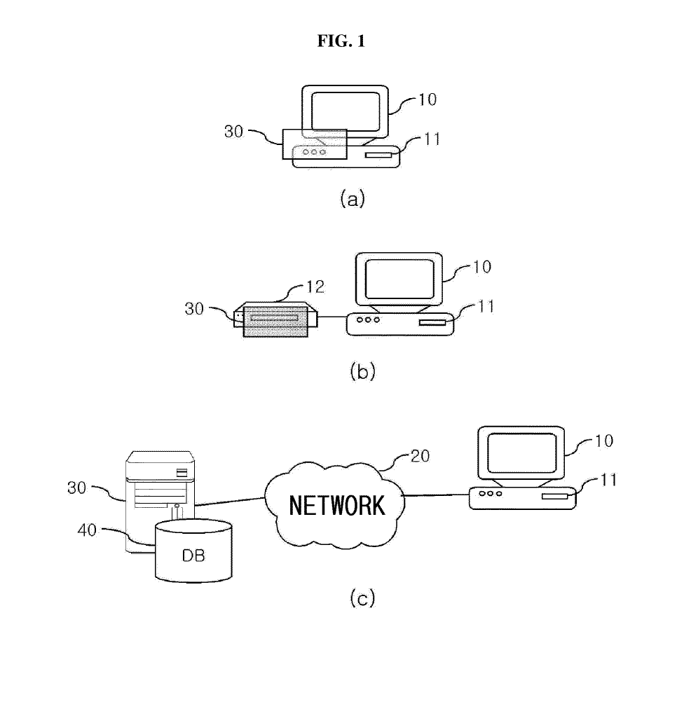

Next, examples of entire system configuration for carrying out the present disclosure will be described with reference to FIG. 1. As illustrated in FIGS. 1A to 1C, a digital forensic audit system for analyzing a user's behaviors according to the present disclosure may be implemented by a computer terminal, a program system on an external storage medium, or a server system on a network.

As illustrated in FIG. 1A, an example of an entire system for carrying out the present disclosure may include a computer terminal 10 and a digital forensic audit system 30 which is provided in the computer terminal 10. That is, individual functions of the forensic audit system 30 are implemented by computer programs and installed in the computer terminal 10. The forensic audit system 30 performs forensic analysis on an image of a storage medium 11 of the computer terminal 10, for example, a hard disk, an external storage disk, or a USB memory.

In this case, an entire data image recorded in the storage medium 11 is called as a forensic image. The forensic audit system 30 scans the storage medium to obtain the forensic image to inspect the forensic image.

As illustrated in FIG. 1B, another example of the entire system for carrying out the present disclosure may include a computer terminal 10 and a digital forensic audit system 30 which is installed in an external storage medium 12. In this case, the system 30 installed in the external storage medium 12 is executed by the computer terminal 10.

In this case, the forensic audit system 30 scans an image which is recorded in the storage medium 11 of the computer terminal to extract data (a document file or an event) required for the analysis and record the extracted data in the external storage medium 12. In this case, the forensic audit system 30 is not installed in the computer terminal 10 so that the forensic audit system 30 may analyze a previous status of the computer terminal 10.

Next, as illustrated in FIG. 1C, another example of the entire system for carrying out the present disclosure includes a computer terminal 10 and a forensic audit system 30 which are connected through a network 20. The entire system may further include a database 40 which stores necessary data.

The computer terminal 10 is a usual computing terminal such as a PC, a notebook computer, or a netbook which is used by a user in an organization.

The forensic audit system 30 is a normal server and is connected to the network 20 to directly access the storage medium 11 of the computer terminal 10 to scan the data recorded thereon and analyze the forensic image. The forensic audit system 30 extracts data (a document file or an event) required for analysis and records the extracted data in the database 40.

The database 40 is a general storage medium which stores data required for the forensic audit system 30 to store an event, a document file, and an analysis result which are extracted from the forensic image. The data which is stored in the database 40 is stored in the storage medium 11 or the external storage medium 12 in the above-described examples of FIGS. 1A and 1B.

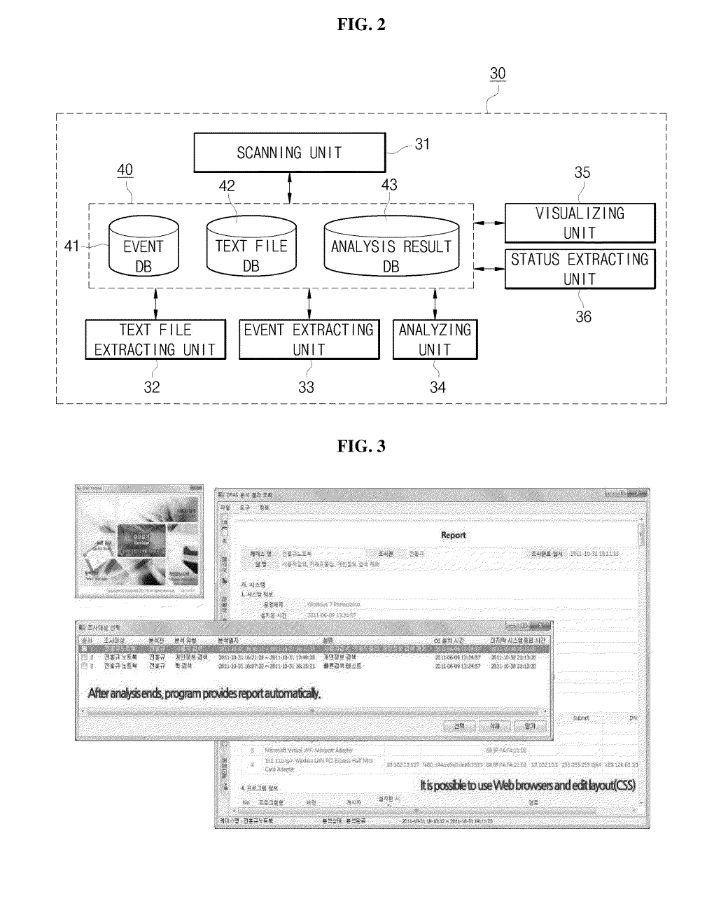

Next, the digital forensic audit system for analyzing a user's behaviors according to the exemplary embodiment of the present disclosure will be described in more detail with reference to FIG. 2.

As illustrated in FIG. 2, the forensic audit system 30 according to the exemplary embodiment of the present disclosure includes a scanning unit 31, a document file extracting unit 32, an event extracting unit 33, an analyzing unit 34, and a visualizing unit 35.

The scanning unit 31 scans an image (or a forensic image) recorded on the storage medium 11. The recorded image (or the forensic image) is mainly divided into a file system and a file itself. The file system includes a directory structure and information (meta information) regarding the files. The files recorded in the storage medium 11 are searched and extracted by the file system.

The file itself is divided into a general document file, an execution file, a log file, and a registry file. The document file refers to a data file such as a text, a document, an image, a voice, and a moving picture and the execution file refers to an executed file such as an application program or a system program. The log file refers to a file in which a log which is executed by the system or the application program is recorded. The registry file refers to a file in which a status of the system is recorded and the status of the system or a status or a log of the application program is recorded.

The scanning unit 31 extracts and stores file system information, the document file, the log file, and the registry file. The scanning unit 31 desirably stores the document file itself. Accordingly, the execution file for execution is not separately stored. However, the information on the execution file which is installed in the system is extracted by the registry analysis.

The scanning unit 31 may scan the recorded image of the storage medium 11 to search and restore a deleted file without using the file system.

The document file extracting unit 32 extracts a logical level document file and an attribute of the document file from the scanned image.

As described above, the scanned image refers to the file system information, the document file, the log file, and the registry file. Accordingly, the document file extracting unit 32 extracts the document file and the attribute thereof from the file system information, the document file, the log file, and the registry file.

The document file includes not only data file such as a text, a document, an image, a voice, and a moving picture, but also a mail and an internet temporary file.

In the meantime, if the document file (hereinafter, referred to as a upper level file) includes document files (hereinafter, referred to lower level files), the document file extracting unit 32 extracts the lower level files as one document file.

If the document file is a mail file, one file includes one message or one file includes a plurality of messages. In this case, in the latter case, one mail file includes a plurality of message files. Therefore, in this case, each of the message files may be stored as one document file. The mail file is the upper level file and the lower level file of the mail file is the message file. Each of the messages may include an attached file. In this case, the attached file is a lower level file and the upper level file of the attached file is the message file.

If the document file is a zip file, compressed files are lower level files and a file which compresses files is the upper level file. In the above description, if the zip file is attached when the message is transmitted/received, the mail file-the message file-the attached file-compressed files are configured as a hierarchical structure.

The attribute of the document file includes a size of the file, a file name, a stored location, a generation date, a stored date, and a corrected date. The message file has a sending date or a received date, a sender and a receiver, and a title as attributes.

Among these attributes, an attribute related to a time is referred to as a time attribute. The time attribute includes the stored location, the generation date, the stored date, the corrected date, the sending date, or the received date.

Next, a status extracting unit 36 extracts the system status from the recorded image. The system status includes installation information of the hardware or the software which is installed in a computer system of the computer terminal 10.

Next, the event extracting unit 33 extracts an event including time of occurrence from the recorded image and extracts the event from an attribute of the document file related to the time (hereinafter, referred to as a time attribute).

The event means occurrence of an event in the computer system. As a genuine event, a system is turned on/off, an application program starts or ends, an application program is installed or uninstalled, an external memory such as the USB memory is inserted or removed, or the system is connected or disconnected to or from the network.

The event may be extracted by the attribute of the document file which is related to the time. As the event which is extracted by the attribute of the document file, cases where the document file is generated or corrected and the mail is transmitted or received may be extracted.

The event may be extracted by the system status which is related to the time. A case when the application program or the hardware device (or a driver) is installed or uninstalled may be extracted as an event.

In the meantime, the event extracting unit 33 extracts an event of the upper level file as an event of the lower level file.

For example, an event that the mail is transmitted or received is extracted by the transmitted date or the received date of the mail message with respect to the mail message and the document file which is attached to the message is a lower level file of the message so that the event that the mail is transmitted or received is extracted by the transmitted/received date with respect to the attached document file.

The analyzing unit 34 analyzes the document file or the event by the attribute and the time.

Specifically, if occurrence times of at least two events are equal, the analyzing unit 34 sets a correlation of the events.

In this case, the event occurrence time may be set as a range of the time. For example, a time when the USB memory is inserted into the computer terminal 10 and then removed may be set as an occurrence time of an event when the USB is inserted.

Alternatively, if the event occurrence time is a specific time, a range of time including a predetermined time before and after the even occurrence time may be set as the event occurrence time. For example, in the case of an event for generating the document file (event extracted from the generation date), 10 minutes before and after the generation date may be set as the event occurrence time.

If the occurrence times of two events (or time range) overlap, the analyzing unit 34 determines that the occurrence times are same. For example, when a time when a word processing document (document file) is generated is between 2:50 and 3:10 and a time when the USB is inserted is between 3:05 and 4:00, times overlap for five minutes starting from 3:05, so that the analyzing unit 34 determines that the occurrence times of the events are equal.

Accordingly, the event for generating the document file and the event for inserting the USB memory have a correlation.

Next, if the event (a first event) extracted by the document file (hereinafter, a first document file) has the correlation with other event (hereinafter, a second event), the analyzing unit 34 sets the correlation between the first document file and the second event.

In the above-described example, a correlation is set between the word processing document and the event for inserting the USB memory.

If the file name of the event is equal to the file name of the document file, the analyzing unit 34 sets the correlation between the event and the document file.

The visualizing unit 35 displays the analyzed result (hereinafter, referred to as an analysis result) on a time coordinate. Specifically, the visualizing unit 35 sets a horizontal axis of the coordinate as an axis of the time and a vertical axis as an event or a document file to display the analysis result.

On the vertical axis, the event or a type (or classification) of document file is displayed so as to be distinguished. When an event on the vertical axis or an event corresponding to the type of the document file occurs, the event which occurs is displayed on the time coordinate. In this case, the horizontal axis (or the time axis) is divided at an interval of a unit time. Desirably, one day is set as one unit. Alternatively, the horizontal axis may be set by a time, a week, a month.

If at least one event occurs on a corresponding date, it is displayed that there is an event on the coordinate of the corresponding date as a box shape. However, since a plurality of events may be performed on the corresponding date, when the box is clicked or is touched with a mouse, the contents of the plurality of events may be displayed on a screen.

The visualizing unit 35 displays a rod (hereinafter, referred to as a time line) which displays a section of the horizontal axis and adjusts the section of the horizontal axis by adjusting the width of the rod between the left and right. Prior to this, on the time coordinate, the entire section of the horizontal axis is adjusted in accordance with the section of the rod which is displayed in the time line. That is, only event which occurs only at a time corresponding to the section of the rod is displayed.

If the time line becomes narrow, the entire time section of the coordinate to be displayed is reduced and events are displayed in more detail on the coordinate. For example, the unit of the time axis is changed from one day into one hour. In contrast, if the time line becomes wider, the entire time section of the coordinate to be displayed becomes wider and the event is displayed to be shortened.

Next, examples of a screen of the digital forensic audit system for analyzing a user's behaviors according to the exemplary embodiment of the present disclosure will be described in more detail with reference to FIGS. 3 to 8.

As illustrated in FIG. 3, if the forensic audit system 30 is executed, a target storage medium of the forensic audit is selected.

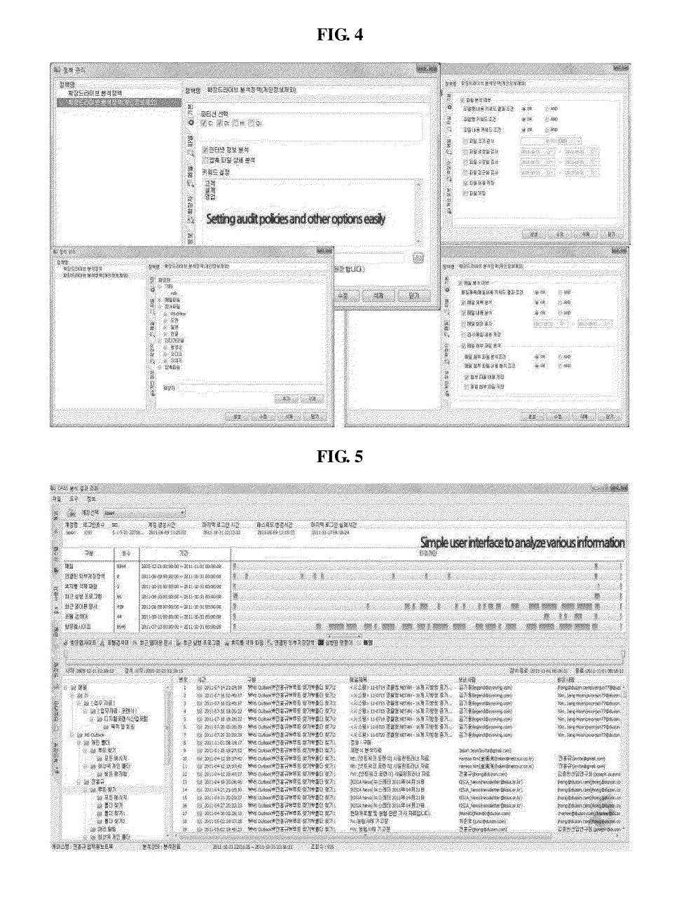

FIG. 4 is a screen for selecting an automatic analyzing option in the forensic audit system 30. A partition of the storage medium to be analyzed is selected or whether to analyze the Internet or the mail is selected.

FIG. 5 is an example of a screen which visualizes the analysis result of the forensic audit system. The time coordinate is displayed between the center and upper portion of FIG. 5. The type of the document file (type according to the attribute) such as the mail, the connected external storage device, a deleted file of the trash box, and a recently executed program, or an event is arranged on the vertical axis and the time is displayed on the horizontal axis. The events which occur within the corresponding time range are displayed. On the screen, the red squares indicate parts where the events occur.

The time line is displayed at the center of FIG. 5. The time line moves the positions at both sides in the rod shape. If both positions are defined, the portion between both positions becomes a display section. The entire section of the horizontal axis of the time coordinate is changed into the display section.

In the lower end of FIG. 5, the document files which are displayed on the horizontal axis of the time coordinate or the specific document files or the events which belong to an event group are displayed. In this case, the document files or the events are classified as a hierarchy structure at the left side and the details of the document files or the events are displayed at the right side.

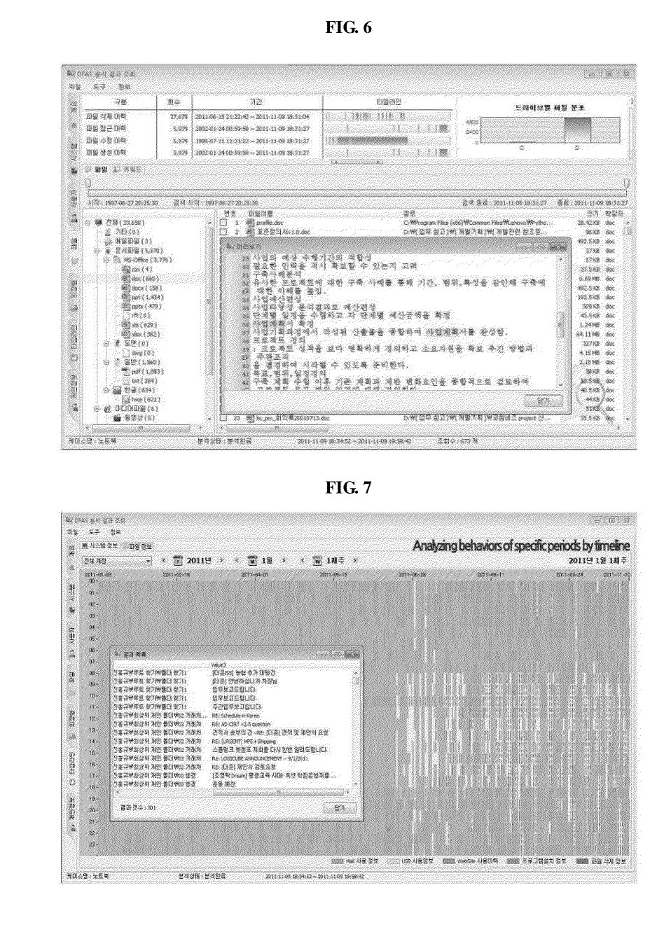

FIG. 6 is a screen which shows a preview of the text in the case of the file including a text among the document files.

FIG. 7 displays the document file or the event as the time coordinate but the horizontal axis and the vertical axis are coordinates determined by time. That is, the horizontal axis is set in the unit of day and the vertical axis is set in the unit of time to display the events which occur in each unit time.

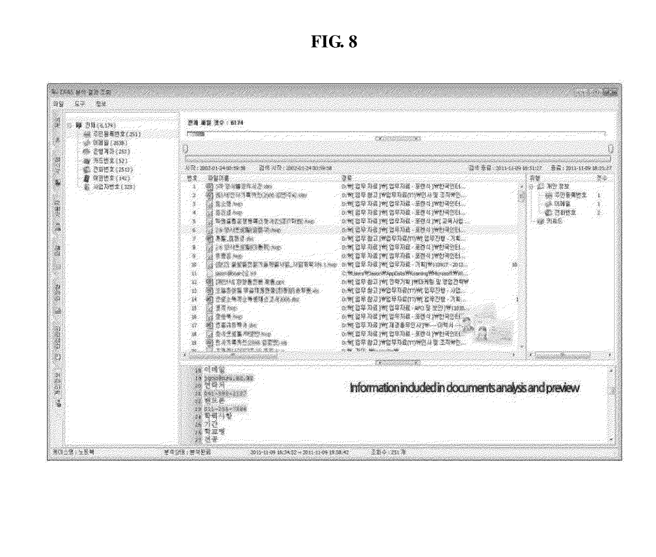

FIG. 8 is a screen that when the document file includes a text, searches and displays the document file having a constant pattern in the text or a corresponding text portion. For example, if there is information which matches a pattern such as a resident registration number, a mail address, or a bank account, the information is displayed.

From the foregoing, it will be appreciated that various embodiments of the present disclosure have been described herein for purposes of illustration, and that various modifications may be made by those skilled in the art without departing from the scope and spirit of the present disclosure. Accordingly, the various embodiments disclosed herein are not intended to be limiting. The scope of the present disclosure should be construed by the appended claims and all technologies within the equivalent scope to that of the present disclosure should be construed as being included in the scope of the present disclosure.

What is claimed is:

1. A digital forensic audit system for analyzing a user's behaviors which scans an image recorded in a storage medium to extract an event and a document file from the image and analyzes the event and the document file to visualize the event and the document file, the system comprising:
a status extracting unit which extracts a system status from the recorded image;
a document file extracting unit which extracts the document file and an attribute of the document file from the recorded image;
an event extracting unit which extracts an event including time of occurrence from the recorded image and extracts an event from an attribute of the document file related to the time (hereinafter, referred to as a time attribute);
an analyzing unit which analyzes the document file or the event by the attribute and the time; and
a visualizing unit which displays the analyzed result (hereinafter, referred to as an analysis result) on a time coordinate.

2. The digital forensic audit system for analyzing a user's behaviors of claim 1, wherein the visualizing unit sets a horizontal axis of the coordinate as an axis of the time and a vertical axis as an event or a document file to display the analysis result.

3. The digital forensic audit system for analyzing a user's behaviors of claim 2, wherein the visualizing unit displays a rod (hereinafter, referred to as a time line) which displays a section of the horizontal axis and adjusts the section of the horizontal axis by adjusting the width of the rod between the left and right.

4. The digital forensic audit system for analyzing a user's behaviors of claim 1, wherein the time attribute of the document file includes a file generation date and a file correction date.

5. The digital forensic audit system for analyzing a user's behaviors of claim 1, wherein if the document file (hereinafter, an upper level file) includes a document file (hereinafter, a lower level file), the document file extracting unit extracts the lower level file as one document file.

6. The digital forensic audit system for analyzing a user's behaviors of claim 5, wherein the event extracting unit extracts an event of the upper level file as an event of the lower level file.

7. The digital forensic audit system for analyzing a user's behaviors of claim 6, wherein if the upper level file is a mail, the lower level file is a file which is attached to the mail and if the upper level file is a zip file, the lower level file is a compressed file.

8. The digital forensic audit system for analyzing a user's behaviors of claim 1, wherein if occurrence times of at least two events are equal, the analyzing unit sets a correlation of the events and sets a correlation between the event and the document file to the document file which is extracted as the event.

9. The digital forensic audit system for analyzing a user's behaviors of claim 1, wherein if a file name of the event is equal to a file name of the document file, the analyzing unit sets the correlation between the event and the document file.
